(19) United States
(12) Patent Application Publication
(10) Pub. No.: US 2025/0063631 A1
(43) Pub. Date: Feb. 20, 2025

(54) MULTI-LINK OPERATION IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US)

(21) Appl. No.: 18/787,999

(22) Filed: Jul. 29, 2024

Related U.S. Application Data
(60) Provisional application No. 63/532,574, filed on Aug. 14, 2023.

(51) Int. Cl. H04W 76/34; H04W 48/10; H04W 88/10

(52) U.S. Cl. CPC H04W 76/34; H04W 48/10; H04W 88/10

(57) ABSTRACT

A basic service set (BSS) corresponding to an access point (AP) affiliated with an AP multi-link device (MLD) is terminated when the AP is removed. The link ID assigned to the AP is no longer assigned to that AP. A BSS corresponding to an AP affiliated with an AP MLD is not terminated when the link on which the AP is operating is disabled. The affiliated AP maintains the link ID assigned to the AP.

### CROSS-REFERENCE TO RELATED APPLICATIONS

This application claims the benefit of priority from U.S. Provisional Application No. 63/532,574, entitled “METHOD AND APPARATUS FOR MULTI-LINK PROCEDURES FOR NEXT GENERATION WLAN SYSTEMS,” filed Aug. 14, 2023, which is incorporated herein by reference in its entirety.

### TECHNICAL FIELD

This disclosure relates generally to a wireless communication system, and more particularly to, for example, but not limited to, a multi-link operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides an access point (AP) multi-link device (MLD) in a wireless network. The AP MLD comprises at least two APs affiliated with the AP MLD and a processor coupled to the at least two APs. The processor is configured to cause removing an AP affiliated with the AP MLD. The processor is configured to cause terminating a basic service set (BSS) corresponding to the AP affiliated with the AP MLD. A link identifier (ID) assigned to the AP is no longer assigned to the AP.

In some embodiments, the processor is further configured to cause advertising removal of the AP through a reconfiguration multi-link element in a broadcast frame.

In some embodiments, the broadcast frame is a beacon frame or a probe response frame.

In some embodiments, a lifetime of the BSS corresponding to the AP affiliated with the AP MLD ends.

In some embodiments, the AP is added back later, the ID is reassigned to the AP.

An aspect of the disclosure provides an access point (AP) multi-link device (MLD) in a wireless network. The AP MLD comprises at least two APs affiliated with the AP MLD and a processor coupled to the at least two APs. The processor is configured to cause disabling a link on which an AP affiliated with the AP MLD is operating. The processor is configured to cause abstaining from terminating a basic service set (BSS) corresponding to the AP affiliated with the AP MLD. The AP affiliated with the AP MLD maintains a link identifier (ID) assigned to the AP.

In some embodiments, the processor is further configured to cause advertising a traffic identifier (TID)-to-link mapping indicating the link to be disabled in a broadcast frame.

In some embodiments, the broadcast frame is a beacon frame or a probe response frame.

In some embodiments, a lifetime of the BSS corresponding to the AP affiliated with the AP MLD continues after disabling the link.

In some embodiments, the link is enabled again later, the ID is assigned to the AP.

An aspect of the disclosure provides a method performed by an access point (AP) multi-link device (MLD) in a wireless network. The method comprises removing an AP affiliated with the AP MLD, the AP MLD comprising at least two APs affiliated with the AP MLD. The method comprises terminating a basic service set (BSS) corresponding to the AP affiliated with the AP MLD. A link identifier (ID) assigned to the AP is no longer assigned to the AP.

In some embodiments, the method further comprises advertising removal of the AP through a reconfiguration multi-link element in a broadcast frame.

In some embodiments, the broadcast frame is a beacon frame or a probe response frame.

In some embodiments, a lifetime of the BSS corresponding to the AP affiliated with the AP MLD ends.

In some embodiments, the AP is added back later, the ID is reassigned to the AP.

An aspect of the disclosure provides a method performed by an access point (AP) multi-link device (MLD) in a wireless network. The method comprises disabling a link on which an AP affiliated with the AP MLD is operating, the AP MLD comprising at least two APs affiliated with the AP MLD. The method comprises abstaining from terminating a basic service set (BSS) corresponding to the AP affiliated with the AP MLD. The AP affiliated with the AP MLD maintains a link identifier (ID) assigned to the AP.

In some embodiments, the method further comprises advertising a traffic identifier (TID)-to-link mapping indicating the link to be disabled in a broadcast frame.

In some embodiments, the broadcast frame is a beacon frame or a probe response frame.

In some embodiments, a lifetime of the BSS corresponding to the AP affiliated with the AP MLD continues after disabling the link.

In some embodiments, the link is enabled again later, the ID is assigned to the AP.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example of multi-link setup in accordance with an embodiment.

FIG. 5 shows an example process of termination of a BSS in accordance with an embodiment.

FIG. 6 shows an example process of a link disablement in accordance with an embodiment.

FIG. 7 shows an example format of an reduce neighbor report element in accordance with an embodiments.

FIG. 8 shows an example format of a basic multi-link element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

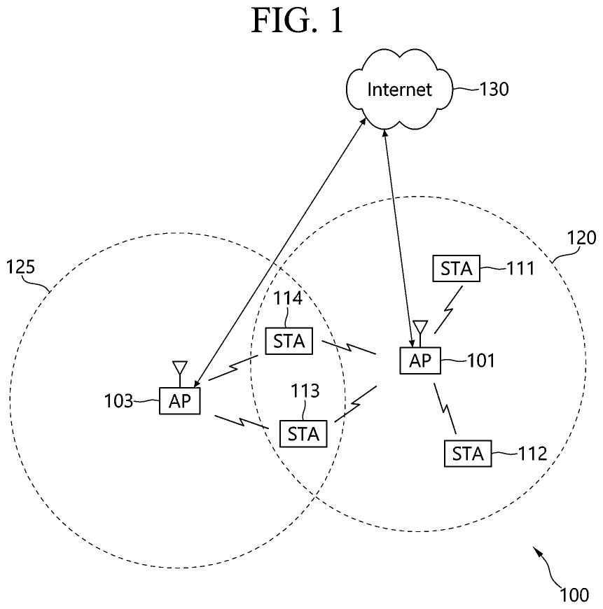

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

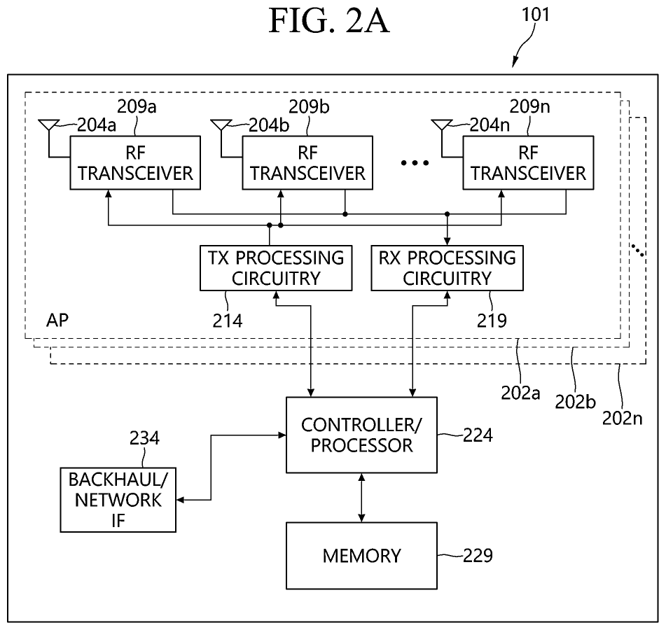

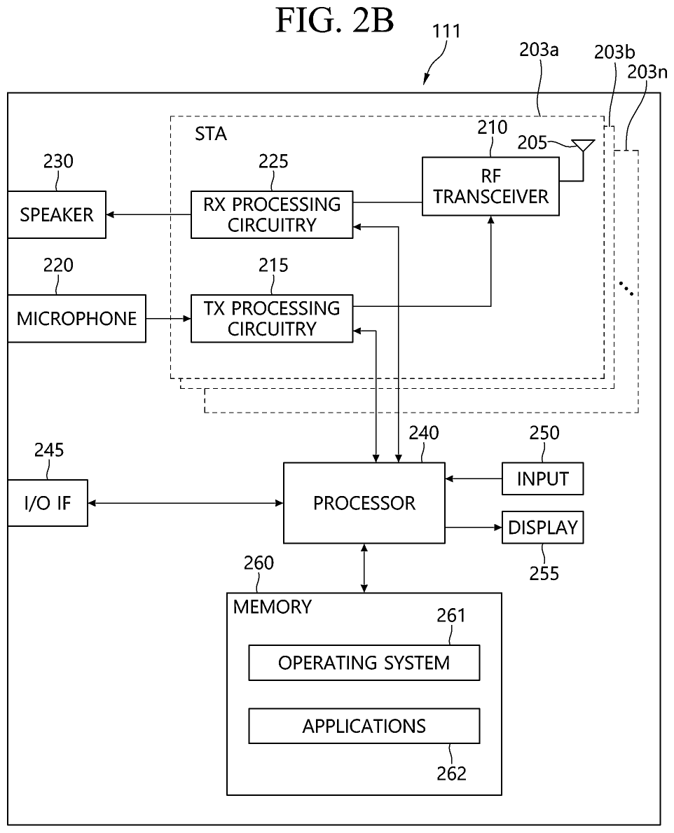

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

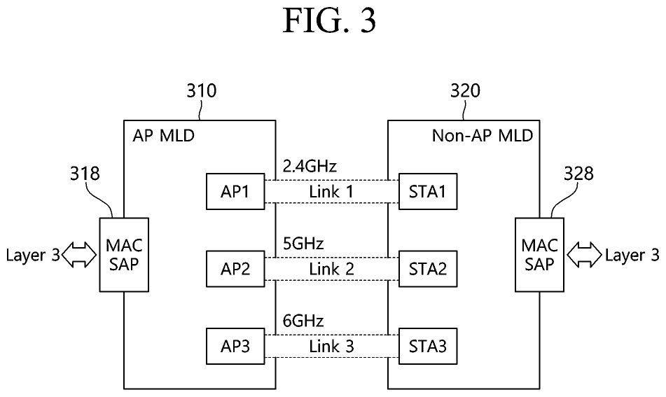

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D3.1, “Wireless LAN Medium Access Control (MAC) and Physical Layer (PHY) Specifications.”

The MLO allows the discovery and setup of multiple links between an AP MLD and a non-AP MLD. In some embodiments, the discovery and the setup of multiple links may take place over a single link.

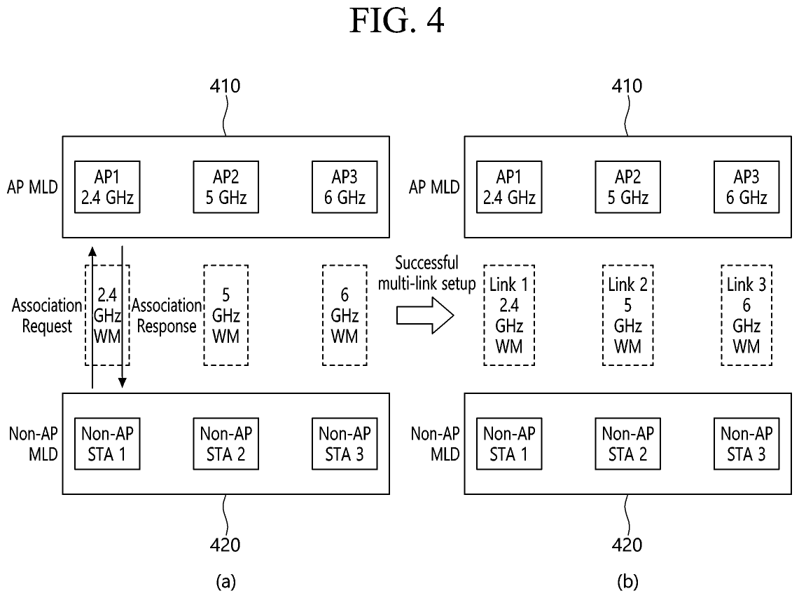

FIG. 4 shows an example of multi-link setup in accordance with an embodiment.

In FIG. 4, AP MLD 410 includes three affiliated APs (e.g., AP 1, AP 2, and AP 3) and non-AP MLD 420 includes three affiliated STAs (e.g., non-AP STA 1, non-AP STA 2, and non-AP STA 3). AP 1 operates in 2.4 GHz band, AP 2 operates in 5 GHz band, and AP 3 operates in 6 GHz band. In this example of FIG. 4, the non-AP MLD 420 initiates the multi-link setup procedure, and an association request frame and an association response frame are exchanged in the 2.4 GHz band between AP 1 and non-AP STA 1. This procedure is to establish three links between AP MLD 410 and non-AP MLD 420: one in the 2.4 GHz band, one in the 5 GHz band, and one in the 6 GHz band. After successful multi-link setup, three links are established between AP MLD 410 and non-AP MLD 420.

In current WLAN systems, a procedure for advertising multi-link information is not defined. Therefore, this disclosure presents various embodiments regarding the advertisement of multi-link information.

In current WLAN systems, the usage of the reduced neighbor report (RNR) element for non-transmitted BSSID in the context of multi-link operation is not defined. Therefore, this disclosure presents various embodiments regarding the usage of the RNR element for non-transmitted BSSID in the multi-link operation.

In some embodiments, when an AP affiliated with an AP MLD is removed, for example and without limitation, using a multi-link reconfiguration procedure, the lifetime of the AP may be ended. In other words, when the AP affiliated with the AP MLD is removed, the BSS of the affiliated AP is terminated, and the link ID assigned to the AP is no longer assigned to the AP. In this scenario, when the removed AP is added back at a later time, the same BSSID or different BSSID and the same link ID or different link ID can be assigned to the AP.

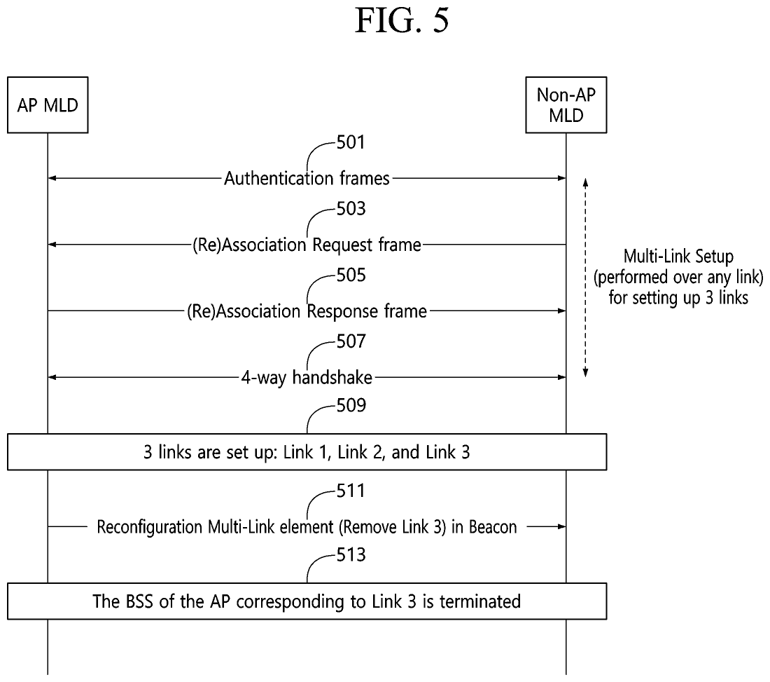

FIG. 5 shows an example process of termination of a BSS in accordance with an embodiment. The scenario and operations depicted in FIG. 5 are also for illustration purposes and do not limit the scope of this disclosure to any particular implementations.

Referring to FIG. 5, a multi-link setup procedure is performed during operation 1501 to operation 507, which can be performed over any link among multiple links (three links in the example of FIG. 5).

In operation 501, AP MLD and non-AP MLD perform authentication process by exchanging authentication frames.

In operation 503, the non-AP MLD sends an association request frame (or re-association request frame) to the AP MLD.

In operation 505, the AP MLD responds by sending an association response frame (or re-association response frame) to the non-AP MLD.

Subsequently, in operation 507, AP MLD and non-AP MLD perform 4-way handshake. As a result, the multi-link setup procedure is successfully completed. Therefore, three links (Link 1, Link 2, and Link 3) are set up between AP MLD and non-AP MLD as shown in operation 509.

In operation 511, the AP MLD sends a beacon frame or a probe response frame that includes a reconfiguration multi-link element indicating the removal of Link 3 (or the removal of an AP corresponding to Link 3) between AP MLD and non-AP MLD.

In operation 513, the AP corresponding to Link 3 is removed and the BSS of the AP is terminated as specified by the reconfiguration multi-link element.

In some embodiments, when an AP affiliated with an AP MLD is removed, for example, by a multi-link reconfiguration procedure (e.g., reconfiguration multi-link element), the lifetime of the BSS of the AP does not end with the removal of the AP. Therefore, the lifetime of the BSS of the AP continues even after the removal of the AP from the AP MLD. In an embodiment, when the removed AP is added back at a later time, the same BSSID and link ID may be assigned to the AP.

In some embodiments, when a link on which an AP affiliated with an AP MLD is operating is disabled for all associated non-AP STAs operating on the same link, for example, by using advertised traffic identifier (TID)-to-link mapping in a beacon frame or a probe response frame, the lifetime of the BSS of the AP is ended. In an embodiment, when the link becomes enabled again at a later time, the same BSSID or different BSSID, and the same link ID or different link ID, may be assigned to the AP. In an embodiment, when the link on which the affiliated AP is operating is disabled and the BSS of the affiliated AP is not terminated, the affiliated AP maintains the link ID assigned to the AP.

In some embodiments, when a link on which an AP affiliated with an AP MLD is operating is disable for all associated non-AP STAS operating on the same link, for example, by using advertised TID-to-link mapping in a beacon frame or a probe response frame, the lifetime of the BSS of the AP does not end but continues. In an embodiment, when the link becomes enabled again at a later time, the same BSSID and the same link ID may be assigned to the AP.

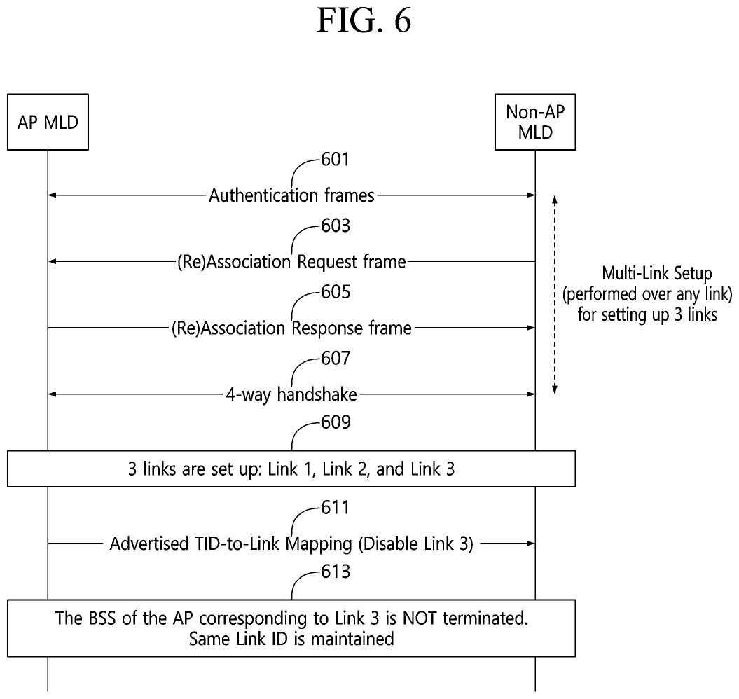

FIG. 6 shows an example process of a link disablement in accordance with an embodiment. The scenario and operations depicted in FIG. 6 are also for illustration purposes and do not limit the scope of this disclosure to any particular implementations.

Referring to FIG. 6, a multi-link setup procedure is performed during operation 1601 to operation 607, which can be performed over any link among multiple links (three links in the example of FIG. 6).

In operation 601, an AP MLD and a non-AP MLD perform authentication process by exchanging authentication frames.

In operation 603, the non-AP MLD sends an association request frame (or re-association request frame) to the AP MLD.

In operation 605, the AP MLD responds by sending an association response frame (or re-association response frame).

Subsequently, in operation 607, AP MLD and non-AP MLD perform 4-way handshake. As a result, the multi-link setup procedure is successfully completed. As shown in operation 609, three links (Link 1, Link 2, and Link 3) are set up between AP MLD and non-AP MLD.

In operation 611, the AP MLD advertises a TID-to-link mapping that indicates to disable Link 3 between the AP MLD and the non-AP MLD.

In operation 613, the BSS of the AP corresponding to Link 3 is not terminated but continues. As a result, the same link ID is maintained even after the disablement of Link 3 associated with the AP.

In some embodiments, when a first AP is affiliated a first AP MLD and corresponds to a non-transmitted BSSID, a beacon frame or a probe response frame transmitted by a second AP, which is associated with a transmitted BSSID in the same multiple BSSID set as the first AP, may include a target beacon transmission time (TBTT) information field in a reduced neighbor report (RNR) element. A TBTT information length subfield in the reduced neighbor report element may be set to 16 or higher for each of the APs (i.e., all APs) affiliated with the same AP MLD that includes the first AP corresponding to the non-transmitted BSSID. Therefore, the second AP may transmit the reduced neighbor report element for the first AP.

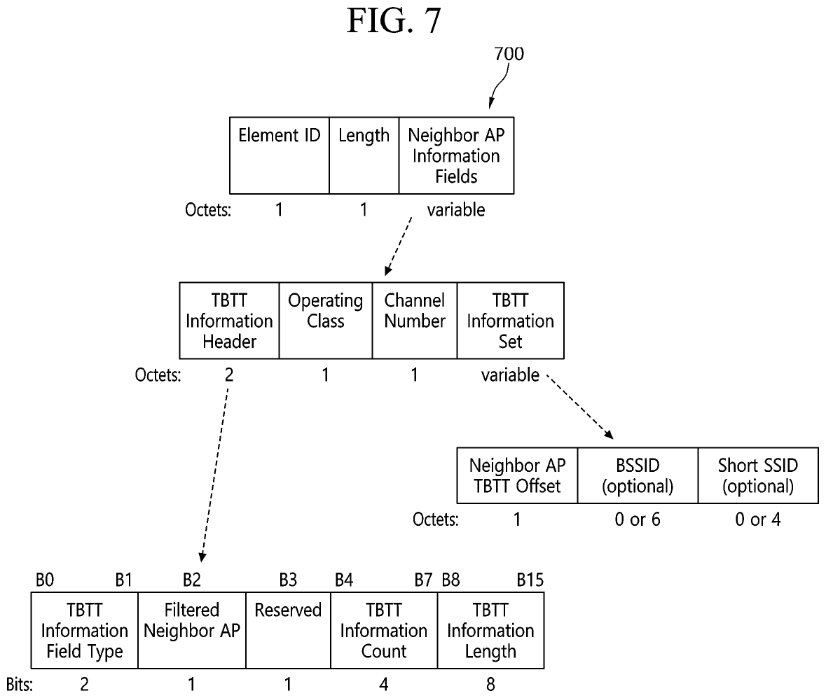

FIG. 7 shows an example format of an reduce neighbor report (RNR) element 700 in accordance with an embodiments.

Referring to FIG. 7, the RNR element 700 includes channel and other information related to neighbor APs. The RNR element 700 includes an element ID field, a length field, and one or more neighbor AP information fields. A neighbor AP information field specifies TBTT and other information related to a group of neighbor APs on one channel. The element ID field includes an identifier of the RNR element 700. The length field indicates a length of the RNR element 700.

The neighbor AP information field includes a TBTT formation header subfield, an operating class subfield, a channel number subfield, and TBTT information set subfield. The TBTT information header field includes a TBTT information field type subfield, a filtered neighbor AP subfield, a reserved field, a TBTT information count subfield, a TBTT information length subfield. The TBTT information field type subfield identifies, together with the TBTT information length subfield, the format of the TBTT information subfield. The filtered neighbor AP subfield is reserved. The TBTT information count subfield indicates a number of TBTT information fields includeded in the TBTT information set subfield. The TBTT inforamtion length subfield indicates a length of each TBTT information field included in the TBTT information set subfield. In some embodiments, the TBTT information length subfield may be set to 16 or higher for each of the APs (i.e., all APs) affiliated with the same AP MLD that includes an AP corresponding to a non-transmitted BSSID. The operating class subfield indicates a channel starting frequency that indicates a primary channel of the BSSs of the APs in the neighbor AP information field. The channel number subfield indicates the last known primary channel of the APs in the neighbor AP information field. The TBTT information set subfield includes one or more TBTT information fields, including a neighbor AP TBTT offset field, an optional BSSID field, and an optional short SSID field. The neighbor AP TBTT offset field indicates the offset to the next TBTT of an AP's BSS from the immediately prior TBTT of the AP that transmits this element. The BSSID field and the short SSID field includes values of corresponding BSSID and short SSID, respectively.

In some embodiments, when a STA affiliated with a non-AP MLD sends a multi-link probe request frame to an AP affiliated with an AP MLD, and the multi-link probe request frame requests a partial set of profiles for one or more APs affiliated with the AP MLD, the multi-link probe request frame may request different sets of elements for different requested APs affiliated with the AP MLD. In an embodiment, a first set of elements is included in a first Per-STA profile element while a second set of elements is included in a second Per-STA profile element. The first set of elements and the second set of elements may be the same or different. In some embodiments, in order to enable the request for different sets of elements for different APs affiliated with an AP MLD, a request element or/and an extended request element may be included in the Per-STA profile subelement. When the requested information for different APs affiliated with the AP MLD is the same, the request element or the extended request element can be placed outside the Per-STA profile subelement, for example, outside the basic multi-link element but within the same frame that includes the basic multi-link element. These embodiments may be applicable when seeking information corresponding to an AP that is not in a multiple BSSID set and that does not correspond to a transmitted BSSID. These embodiments may be also applicable when seeking information corresponding to an AP that is in a multiple BSSID set and corresponds to a transmitted BSSID.

In some embodiments, an AP affiliated with an AP MLD receives a multi-link probe request frame from a STA affiliated with a non-AP MLD. When the multi-link probe request frame requests a partial set of profiles for one or more APs affiliated with the AP MLD and the multi-link probe request frame requests the same or different sets of elements for different requested APs affiliated with the AP MLD, the AP MLD may provide the requested same or different sets of information for the requested APs. The APs affiliated with the AP MLD may deliver the same or different sets of information based on the information requested in the request element or extended request element placed outside or inside the basic multi-link element. These embodiments are applicable when seeking information corresponding to an AP that is in a multiple BSSID set and that does not correspond to a transmitted BSSID. These embodiments are also applicable when seeking information corresponding to an AP that is in a multiple BSSID set and that corresponds to a transmitted BSSID.

In some embodiments, when an AP affiliated with an AP MLD is not in a multiple BSSID set or the AP corresponds to a transmitted BSSID in a multiple BSSID set, the AP may include a basic multi-link element in a beacon frame or a probe response frame that is not multi-link probe response frame that it transmits.

In some embodiments, when an AP affiliated with an AP MLD is not in a multiple BSSID set or the AP corresponds to a transmitted BSSID in a transmitted BSSID in a multiple BSSID set, the AP may not include a basic multi-link element in a beacon frame or in a probe response frame that is not multi-link probe response frame if the AP is the only AP affiliated with the AP MLD.

In some embodiments, when an AP affiliated with an AP MLD is not in a multiple BSSID set or the AP corresponds to a transmitted BSSID in a multiple BSSID set, the AP may include an EPCS (Emergency Preparedness Communications Service) multi-link element in a beacon frame or a probe response frame that is not a multi-link probe response frame that it transmits.

In some embodiments, when an AP affiliated with an AP MLD corresponds to a non-transmitted BSSID set, the AP that corresponds to a transmitted BSSID in the same multiple BSSID set may include a basic multi-link element for the AP MLD in the non-transmitted BSSID profile corresponding to the non-transmitted BSSID carried in the multiple BSSID element in a beacon frame or a probe response frame that is not a multi-link probe response frame that it transmits

In some embodiments, when an AP affiliated with an AP MLD corresponds to a non-transmitted BSSID in a multiple BSSID set, the AP that corresponds to a transmitted BSSID in the same multiple BSSID set may include an EPCS multi-link element for the AP MLD in the non-transmitted BSSID profile corresponding to the non-transmitted BSSID carried in the multiple BSSID element in a beacon frame or a probe response frame that is not a multi-link probe response frame that it transmits.

In some embodiments, an AP affiliated with an AP MLD receives a (re)association request frame on a first link between an AP MLD and a non-AP MLD. The (re)association request frame requests to establish a first set of links between the AP MLD and a non-AP MLD and the first set of links includes the first link. In this scenario, when the AP MLD is not able to accept the first link but able to accept one or more other links in the first set of links, the AP may send a (re)association response frame to the non-AP MLD, indicating the rejection of the setup of the first link while the acceptance of the setup of the one or more other links in the first set of link. In this case, the multi-link setup may be regarded as successful.

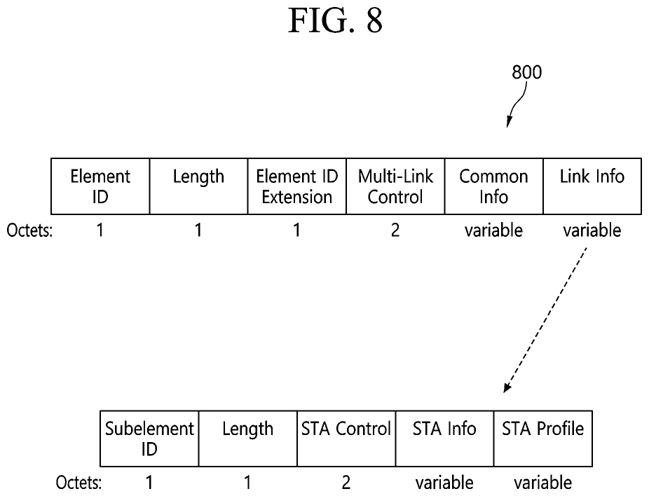

FIG. 8 shows an example format of a basic multi-link element 800 in accordance with an embodiment. The basic multi-link element 800 is one type of multi-link elements. The basic multi-link element 800 carries information related to an MLD and its affiliated STAs that is advertised, for example and without limitation, during multi-link discovery and multi-link setup.

Referring to FIG. 8, the basic multi-link element 800 includes an element ID field, a length field, an element ID extension field, a multi-link control field, a common information (info) field, and a link information field. The element ID field and the element ID extension field identifies the basic multi-link element 800. The length indicates a length of the basic multi-link element 800. The multi-link control field indicates that this element is a basic multi-link element among various multi-link elements and presence of various fields in the common info field. The common info field carries information that is common to all the links. The link info field includes one or more Per-STA profile sub-elements.

A Per-STA profile sub-element includes a sub-element ID subfield, a length subfield, a STA control subfield, a STA info subfield, and STA Profile subfield. The sub-element ID subfield identifies the Per-STA profile sub-element. The length subfield indicates a length of the Per-STA profile sub-element. The STA control subfield and the STA info subfields include various control information and necessary information for a specific STA. The contents of the STA Profile subfield are determined based on whether the Per-STA Profile sub-element carries complete or partial profile.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or proces ses in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) multi-link device (MLD) in a wireless network, comprising:
at least two APs affiliated with the AP MLD; and
a processor coupled to the at least two APs, the processor configured to cause:
removing an AP affiliated with the AP MLD; and
terminating a basic service set (BSS) corresponding to the AP affiliated with the AP MLD, wherein a link identifier (ID) assigned to the AP is no longer assigned to the AP.

2. The AP MLD of claim 1, wherein the processor is further configured to cause:
advertising removal of the AP through a reconfiguration multi-link element in a broadcast frame.

3. The AP MLD of claim 2, wherein the broadcast frame is a beacon frame or a probe response frame.

4. The AP MLD of claim 1, wherein a lifetime of the BSS corresponding to the AP affiliated with the AP MLD ends.

5. The AP MLD of claim 1, wherein the AP is added back later, the ID is reassigned to the AP.

6. An access point (AP) multi-link device (MLD) in a wireless network, comprising:
at least two APs affiliated with the AP MLD; and
a processor coupled to the at least two APs, the processor configured to cause:
disabling a link on which an AP affiliated with the AP MLD is operating; and
abstaining from terminating a basic service set (BSS) corresponding to the AP affiliated with the AP MLD, wherein the AP affiliated with the AP MLD maintains a link identifier (ID) assigned to the AP.

7. The AP device of claim 6, wherein the processor is further configured to cause:
advertising a traffic identifier (TID)-to-link mapping indicating the link to be disabled in a broadcast frame.

8. The AP MLD of claim 7, wherein the broadcast frame is a beacon frame or a probe response frame.

9. The AP device of claim 6, wherein a lifetime of the BSS corresponding to the AP affiliated with the AP MLD continues after disabling the link.

10. The AP device of claim 6, wherein the link is enabled again later, the ID is assigned to the AP.

11. A method performed by an access point (AP) multi-link device (MLD) in a wireless network, comprising:
removing an AP affiliated with the AP MLD, the AP MLD comprising at least two APs affiliated with the AP MLD; and
terminating a basic service set (BSS) corresponding to the AP affiliated with the AP MLD, wherein a link identifier (ID) assigned to the AP is no longer assigned to the AP.

12. The method of claim 11, wherein further comprising:
advertising removal of the AP through a reconfiguration multi-link element in a broadcast frame.

13. The method of claim 12, wherein the broadcast frame is a beacon frame or a probe response frame.

14. The method of claim 11, wherein a lifetime of the BSS corresponding to the AP affiliated with the AP MLD ends.

15. The method of claim 11, wherein the AP is added back later, the ID is reassigned to the AP.

16. A method performed by an access point (AP) multi-link device (MLD) in a wireless network, comprising:
disabling a link on which an AP affiliated with the AP MLD is operating, the AP MLD comprising at least two APs affiliated with the AP MLD; and
abstaining from terminating a basic service set (BSS) corresponding to the AP affiliated with the AP MLD, wherein the AP affiliated with the AP MLD maintains a link identifier (ID) assigned to the AP.

17. The method of claim 16, further comprising:
advertising a traffic identifier (TID)-to-link mapping indicating the link to be disabled in a broadcast frame.

18. The method of claim 17, wherein the broadcast frame is a beacon frame or a probe response frame.

19. The method of claim 16, wherein a lifetime of the BSS corresponding to the AP affiliated with the AP MLD continues after disabling the link.

20. The method of claim 16, wherein the link is enabled again later, the ID is assigned to the AP.
